(19) United States
(12) Patent Application Publication
(10) Pub. No.: US 2006/0228942 A1
(43) Pub. Date: Oct. 12, 2006

(54) Fine wire coaxial connector

(76) Inventors: Kazuya Okano, Kanagawa (JP); Yoshihito Ohkuma, Kanagawa (JP)

Correspondence Address: HARRINGTON & SMITH, LLP, 4 RESEARCH DRIVE, SHELTON, CT, 06484-6212, US

(21) Appl. No.: 10/564,897

(22) PCT Filed: Jul. 16, 2004
(86) PCT No.: PCT/JP04/10221

§ 371 Date: May 8, 2006

(30) Foreign Application Priority Data
Jul. 18, 2003 (JP) 2003-276792

(51) Int. Cl. H01R 9/05

(52) U.S. Cl. 439/579

(57) ABSTRACT

A connector for electric connection. The connector consists of a first housing and a second housing. The connector has an electrically conductive layer on the surface of the first housing for electric connection, the electrically conductive layer having first contact surfaces for contact with a wire core and second contact surfaces for contact with a contact attached to the corresponding second housing. The first contact surfaces are aligned in a row and the second contact surfaces are alternately disposed front and rear in the lower surface of the first housing with respect to the direction of insertion of the connector, providing a first connector.

### TECHNICAL FIELD

The present invention relates to a connector for electrically connecting coaxial cable, especially fine-wire coaxial cable or the like, to a substrate.

### BACKGROUND ART

It is desirable to minimize the mounting area of coaxial cables used, for example, in EMI environments or the like, especially when used in compact devices such as mobile devices. Furthermore, the demands for automation of assembly steps and bend resistance are also increasing

Patent Document 1: JP-A 2001-244030

### PROBLEMS TO BE SOLVED BY THE INVENTION

However, past attempts to make connectors smaller have been restricted by such factors as the area occupied by the contacts, thus making it difficult to further miniaturize the compact connectors that are capable of being used in portable devices or the like.

### MEANS FOR SOLVING THE PROBLEMS

In consideration of the above problems, the present invention offers a first connector to be electrically connected to a second connector; said first connector comprising a first housing and conductive layers for making electrical connections on the surface of said first housing; said conductive layers having first contact surfaces contacting a wire core and second contact surfaces contacting contacts attached to said second housing; said first contact surfaces being aligned in a row, and said second contact surfaces being positioned alternately toward the front and rear with respect to the direction of insertion of the connector on the bottom surface of the first housing. Due to this structure, it is able to contribute to miniaturization of connectors.

Furthermore, the invention offers a first connector wherein the aforementioned second contact surfaces extend from the aforementioned first contact surfaces across the surface of the housing, or extend through through holes formed in the housing.

Additionally, the contacts can be formed separately, or combined with thin-film contacts. This can be achieved with a first connector to be electrically connected to a second connector; said first connector comprising a first housing in which are formed through holes having openings on a top surface and a bottom surface, and conductive layers for making electrical connections on the surface of said first housing, said conductive layers and through holes being positioned in alternating fashion and separate contacts being inserted into said through holes.

The contacts inserted into these through holes have first contact surfaces contacting a wire core and second contact surfaces contacting contacts attached to said second connector.

Furthermore, the aforementioned through holes are formed alternately with respect to conductive layers that pass across the surface, and the aforementioned conductive layers are formed by a MID. By using a MID, the conductive layers can be easily formed even in small spaces. As a result, they can be connected to contacts positioned in a staggered fashion.

The present invention further is such that the aforementioned first housing has a conductive shell, and said shell is electrically connected to a shield of a conductive member connected to said first contact surfaces. Additionally, the first connector has an engaging portion for engaging with the second connector on at least one end with respect to the direction of insertion, and has a recess or a bump for fitting with the second connector. This recess or bump is a bump for preventing erroneous insertion and a recess for receiving the bump. Additionally, with regard to the positioning of the contacts, they are on a second housing affixed to a substrate, and said contacts being positioned in a mutually inverted relationship with adjacent contacts. Due to this inverted relationship, the contacts and the aforementioned second contacts surfaces can be positioned in a staggered fashion.

Furthermore, a second portion has an engaging portion for engaging with the first connector on at least one end with respect to the direction of insertion of the first connector. Additionally, the aforementioned second connector has a bump or recess fitting with the first connector, corresponding to the recess or bump formed in the aforementioned first connector.

### BRIEF DESCRIPTION OF THE DRAWINGS

FIG. 1: FIGS. 1 (a)-(d) is an assembly diagram for a connector according too the present invention.

FIG. 2: FIGS. 2(a) and (b) are perspective diagrams showing connectors of the present invention when fitted together.

FIG. 3: FIG. 3(a) is a section view for the case where the conductive layers contacting the conductor making the electrical connection pass across the surface of the housing, and (a) is a section view for the case where the conductive layers pass through through holes formed in the first housing.

FIG. 4: FIG. 4 is a section view for the case where the contacts are formed separately.

FIG. 5: FIG. 5 is an example of a separate contact.

FIG. 6: FIG. 6 is a section view showing connectors of the present invention when fitted together.

FIG. 7: FIGS. 7(a) and (b) are a top view and a bottom view of the first housing for a connector according to the present invention.

### DESCRIPTION OF REFERENCE NUMBERS

1 support member
2 wire core
3 first housing
4 conductive shell
5 first connector
6 engaging portion of first housing
7 engaging portion of conductive shell
8 second connector
9 engaging portion of second connector
10 insert projection of first housing
11 opening of second connector
13 conductive layer
14 first contact surface
15 second contact surface
16, 17 contact
18 through hole
19 positioning bump
20 recess for receiving positioning bump
21 second housing
22 conductor receiving portion
23 contact
25 engaging portion

### BEST MODE FOR CARRYING OUT THE INVENTION

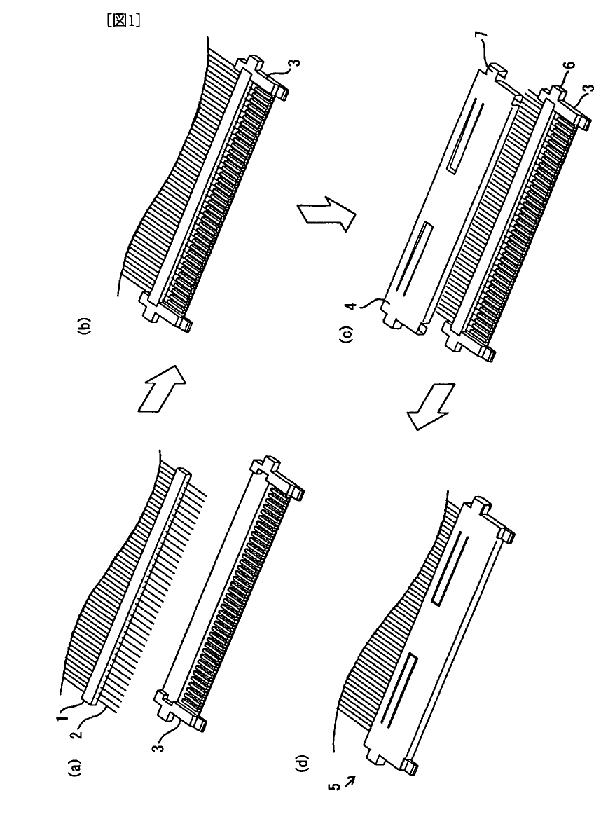

Embodiment of the present invention shall be described below with reference to the drawings. FIGS. 1(a)-(d) are assembly diagrams for a connector according to the present invention. As shown in the drawing, the conductors 2 making electrical connections with external devices and a supporting member 1 supporting the conductors are connected at corresponding positions of a first housing 3 to achieve the state shown in FIG. 1(b). As further shown in (c), a shell 4 having conductivity such as a metal or the like is connected to the first housing 3. In this case, when a coaxial cable is used for example, the shell 4 is electrically connected to the shield wire of the cable. As a result, the shell will have an electromagnetic shield effect. Additionally, the shell 4 has engaging portions 7 for engaging with a second connector, and is affixed so as to cover the engaging portions 6 of the first housing 3. The engaging portions may be formed on either the first housing 3 or the metallic shell 4. In this way, a first connector 5 is formed as shown in (d).

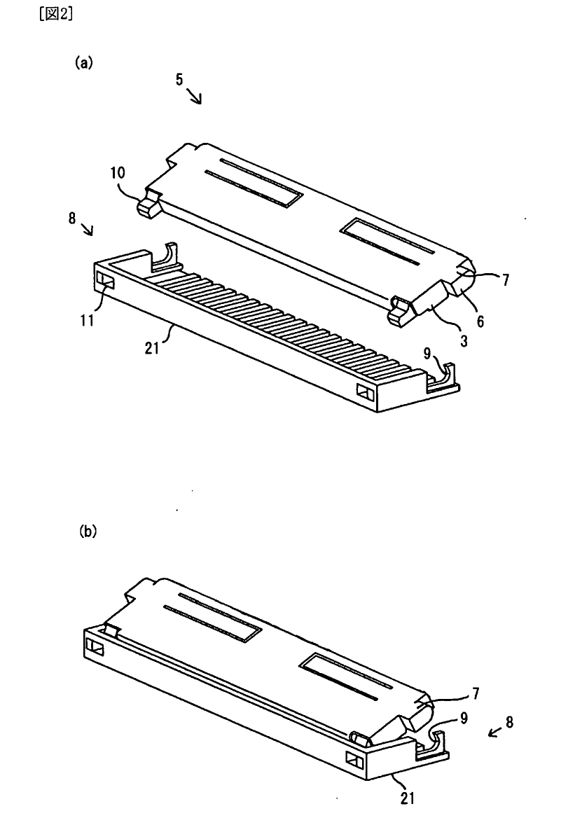

Next, the manner in which a first connector and second connector fit together shall be described. As shown in FIG. 2(a), the first connector 5 is inserted and fitted from above the contacts into the second connector 8. According to FIG. 2(a), the projections 10 of the first housing are inserted into the corresponding openings 11 in the second connector, then the projections (not shown in the drawing) are rotated about a fulcrum and inserted into the second connector 8 as shown in FIG. (b). At this time, positioning bumps and bump receiving portions (neither shown in FIGS. 2(a) and (b)) on the bottom surface of the first housing 3 and the top surface of the second housing 21 are formed so as to prevent erroneous insertion, as shall be described in further detail below. Additionally, engaging portions of the first housing or the shell provided on the housing and engaging portions of the second housing engage so as to ensure that the connectors are fitted together. In this way, the connectors are reliably fitted together.

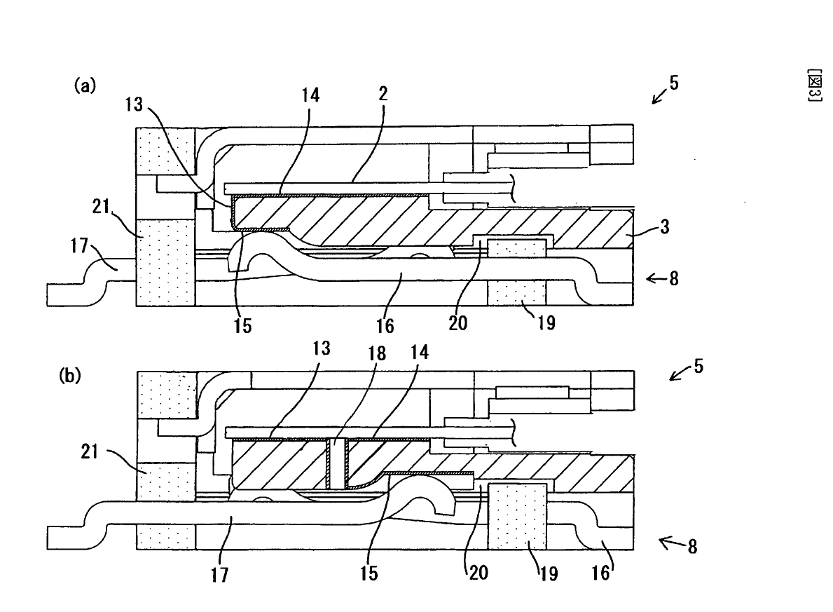

Next, the first connector shall be described. FIG. 3(a) is a section view for the case where conductive layers 13 contacting the conductors 2 making the electrical connection pass across the surface of the housing 3, and (b) is a section view for the case where the conductive layers 13 pass through through holes 18 formed in the first housing 3. As shown in FIG. (a), the conductive layers 13 have first contact surfaces 14 on the top of the housing and second contact surfaces 15 on the bottom of the housing. Additionally, the conductive layers 13 communicate with the second contact surfaces by passing across the surface of the housing, in other words, along the outside of the housing. The first contact surfaces 14 are electrically connected to the conductor 2 by soldering or the like, and the first contact surfaces centered on the portions which are to achieve contact are aligned in a roughly lateral direction. Additionally, the second contact surfaces 15 make contact with contacts 16 of the second housing 21 to achieve electrical communication. Additionally, the contacts 16 and 17 of the second housing are oriented in mutually opposite directions, in other words are mutually inverted as shown in FIGS. (a) and (b).

FIG. 3(b) shows how the first contact surfaces 14 of the conductive layers 13 communicate with the second contact surfaces 15 via the through holes 18. The first contact surfaces 14 of the conductive layers 13 contact the conductors 2 to achieve electrical communication, and the second contact surfaces contact the contacts 17 of the second housing 21 to achieve electrical communication.

As shown in FIGS. 3(a) and (b), positioning bumps 19 used when fitting together the first connector 5 and the second connector 8 are formed on the second housing 21, and recesses 20 for receiving these bumps are formed on the first housing 3. This enables erroneous insertion to be prevented. However, the relationship between the bumps and the recesses may be reversed. That is, the recesses may be formed in the second housing and the positioning bumps formed in the second housing so as to be received in the recesses.

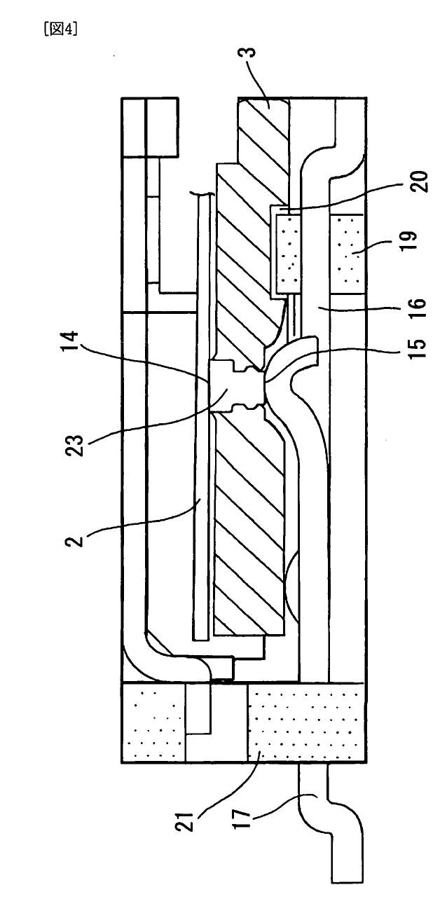

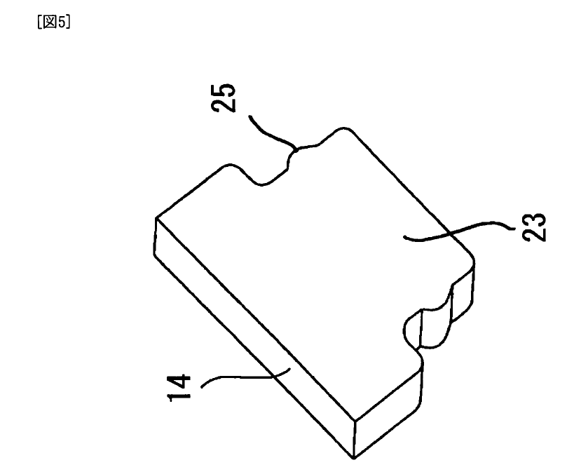

FIG. 4 shows another embodiment of the present invention, having through holes separate from the through holes 18 in which the conductive layers 13 are formed. Separately formed contacts 23 are inserted into these through holes, and the bottom surface of the contact forms second contact surfaces 15. Additionally, the top surfaces of the contacts 23 contact the conductors 2 as first contact surfaces 14. A specific example of the structure of these contacts 23 is shown in FIG. 5, having an engaging portion 25 below the first contact surface 14. When the contact 23 is inserted into the through hole, the engaging portion 25 engages with the wall surface of the through hole. At this time, the contact 23 can be reliably affixed if a recess (not shown) is formed in the wall surface to receive the engaging portion 25. However, the invention is not limited thereto, and those skilled in the art will be able to conceive of other shapes or means for forming the contact 23 separately and holding the contact in the through hole.

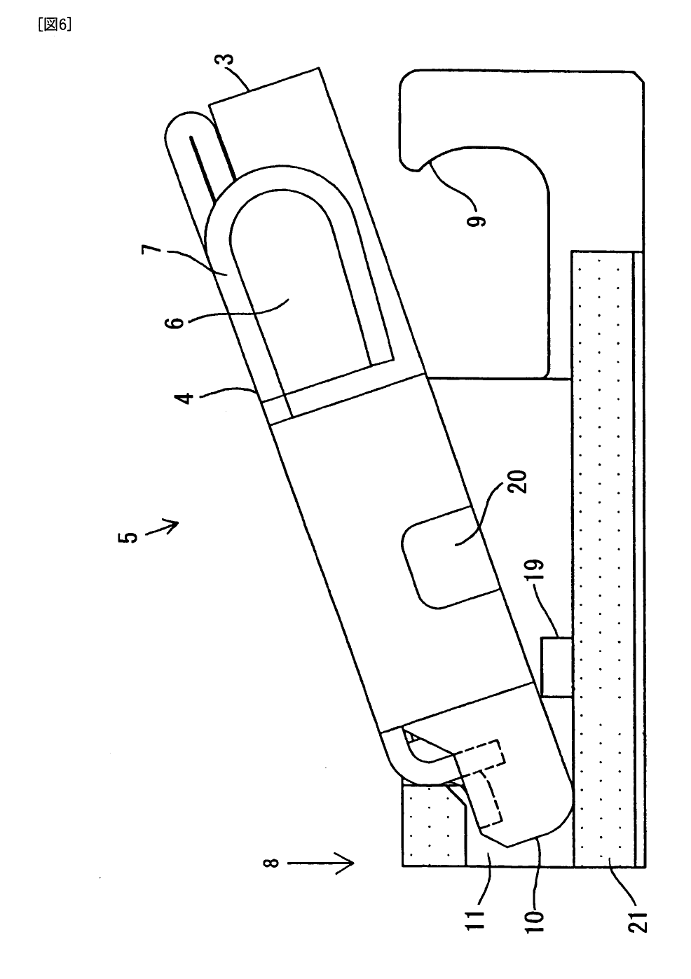

FIG. 6 shows a section view of the first connector 5 and the second connector 8 when fitted together. As described above, projections 10 provided on the first housing 3 are inserted into orifices or openings 11 provided on the second housing 21, and further, positioning bumps 19 provided on the second housing fit with recesses 20 on the first housing. Furthermore, when engaging the first connector 5 and the second connector 8, the engaging portions of the first connector are in such a state that the engaging portions 6 of the first housing are covered by the engaging portions 7 of the shell 4, and the engaging portions 6, 7 are then inserted into the engaging portions 9 of the second connector. At this time, the engaging portions 9 of the second connector are curved so as to cover a portion of the engaging portions 6 of the first housing or the engaging portions 7 of the shell 4, and because of this structure, they will not become disengaged even upon receiving an impact. The connectors are fitted in this way. Next, the arrangement of conductive layers in the first connector shall be described.

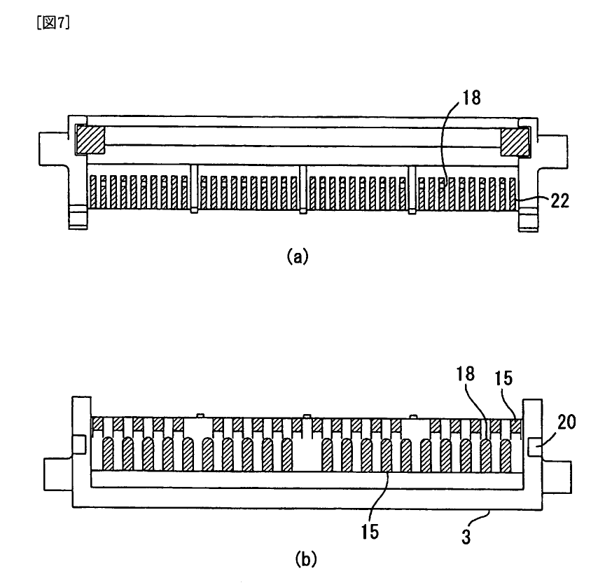

FIG. 7(a) is a top view of the first housing 3 and (b) is a bottom view. The top view shown in FIG. (a) shows that corresponding conductor receiving portions 22 are arranged in a horizontal row and allow conductors to be connected to make electrical connections. Additionally, the through holes 18 have conductive layers formed on their entire inner surface, and their openings are formed to be narrower than the width of the conductor receiving portions 22. As a result, the conductor receiving portions 22 are continuous in the periphery of the through holes 18. That is, the conductor receiving portions 22 are not cut off by the openings of the through holes 18. Therefore, electrical communication can be made to reach the bottom surface no matter to which portions of the conductor receiving portions 22 the wire core is connected. In the bottom view of FIG. (b), the corresponding contacts of the second housing are the portions to be connected, with contacts that are wider than the conductor receiving portions 22 being arranged in a staggered formation, and second contact surfaces 15 being arranged in a staggered formation on the bottom surface of the housing in correspondence thereto. Additionally, as shown in FIGS. 3(a), (b) and their descriptions, the first housing 3 has second contact surfaces 15 passing across the surface of the housing and second contact surfaces 15 passing through the through holes 18, and these are positioned alternately, so that the second contact surfaces are also arranged in a staggered formation corresponding to the contacts. Additionally, as shown in the bottom view (b), the recesses 20 for receiving the positioning bumps in order to prevent erroneous insertion are formed on both sides of the first housing 3.

In this way, the conductive layers are arranged in a single row on the top side of the first housing, and the layers are arranged in a staggered formation on the bottom side, thus enabling the mounting area of the connector to be reduced. In this case, the conductive layers should preferably be formed of a so-called MID (Molded Interconnect Device). By using a MID, it is possible to reliably form conductive layers in a tiny area, and particularly in the case of the present invention, inside the through holes provided in the first housing. Additionally, by using an MID, it is possible to reliably form conductive layers even in a small housing, so as to be able to reduce the overall height of the connector. Furthermore, the number of parts and number of assembly steps can be reduced. As a result, this largely contributes to lower costs for producing thin connectors. Additionally, the connector of the present invention allows the mounting area to be reduced by positioning the contacts and corresponding contact surfaces in a staggered formation, thus enabling high-density mounting. Furthermore, it can be used in an environment where EMI or the like is present because a conductive shell is used.

Embodiments of the present invention have been described above, but the present invention is not limited thereto. For example, the positioning bumps 19 can be formed on the first housing side, and the recesses 20 receiving them may be formed on the second housing side. Additionally, these bumps may be formed on only one side, either the right side or left side of the connector. Additionally, while the engaging portions formed in the first connector are the engaging portions 6 formed in the first housing 3 and the engaging portions 7 formed in the shell in the present embodiment, similar effects can be achieved by using just one of these.

Additionally, as described above, the connector of the present invention can use thin film contacts due to a MID and contacts formed separately, so that it is possible to use contacts formed by a MID and contacts formed separately in combination.

Due to the present invention, connectors can be formed at high density, thus reducing the mounting area. Furthermore, it can offer contacts that prevent erroneous fittings, and which do not become disengaged even when receiving an impact.

1. A first connector to be electrically connected: to a second connector; said first connector comprising a first housing and conductive layers for making electrical connections on a surface of said first housing; said conductive layers having first contact surfaces contacting a wire core and second contact surfaces contacting second contacts attached to a second housing of said second connector; said first contact surfaces being aligned in a row, and said second contact surfaces being positioned alternately toward the front and rear with respect to the direction of insertion of the connector on the bottom surface of the first housing.

2. A first connector in accordance with claim 1, wherein said second contact surfaces extend from said first contact surfaces across the surface of the housing.

3. A first connector in accordance with claim 1, wherein said second contact surfaces extend from said first contact surfaces through though holes formed in the first housing.

4. A first connector to be electrically connected to a second connector; said first connector comprising a first housing in which are formed through holes having openings on a top surface and a bottom surface, and conductive layers for making electrical connections on the surface of said first housing, said conductive layers and through holes being positioned in alternating fashion and separate contacts being inserted into said through holes.

5. A connector in accordance with claim 4, wherein the contacts inserted into the through holes have first contact surfaces contacting a wire core and second contact surfaces contacting contacts attached to said second connector.

6. A first connector in accordance with claim 3, wherein said through holes are formed alternately with respect to conductive layers that pass across the surface.

7. A connector in accordance with claim 1, wherein said conductive layers are formed by a MID.

8. A first connector in accordance with claim 1, wherein said first housing has a conductive shell, and said shell is electrically connected to a shield of a conductive member connected to said first contact surfaces.

9. A first connector in accordance with claim 1, having an engaging portion for engaging with the second connector on at least one end with respect to the direction of insertion.

10. A first connector in accordance with claim 1, having a recess or a bump for fitting with the second connector.

11. A second connector to be electrically connected to a first connector; the second connector comprising a second housing affixed to a substrate, said housing having contacts, and said contacts being positioned in a mutually inverted relationship with adjacent contacts.

12. A second connector in accordance with claim 11, wherein the second connector has an engaging portion for engaging with the first connector on at least one end with respect to the direction of insertion of the first connector.

13. A second connector in accordance with claim 11, wherein the second connector has a bump or recess fitting with the first connector.

14. A connector comprising a first connector in accordance with claim 1, and the second connector connected to the first connector, wherein the second connector comprises the second housing affixed to a substrate, said second housing having said second contacts thereon, and wherein said second contacts are positioned in a mutually inverted relationship with adjacent ones of the second contacts.
